(19) United States
(12) Patent Application Publication
(10) Pub. No.: US 2023/0374827 A1
(43) Pub. Date: Nov. 23, 2023

(54) MOTOR VEHICLE LOCK

(71) Applicant: Brose Schließsysteme GmbH & Co. Kommanditgesellschaft, Wuppertal (DE)

(72) Inventors: Ludger GRAUTE, Essen (DE); Markus ZILLERT, Düsseldorf (DE); Serkan GÜLKAN, Hattingen (DE)

(73) Assignee: Brose Schließsysteme GmbH & Co. Kommanditgesellschaft, Wuppertal (DE)

(21) Appl. No.: 18/008,171

(22) PCT Filed: Jun. 1, 2021
(86) PCT No.: PCT/EP2021/064663

§ 371 Date: Jul. 13, 2023

(30) Foreign Application Priority Data
Jun. 4, 2020 (DE) 10 2020 114 902.6

(51) Int. Cl. E05B 77/06; E05B 85/26

(52) U.S. Cl. CPC E05B 77/06; E05B 85/26; E05B 81/06

(57) ABSTRACT

A motor vehicle lock having a striker plate and at least one pawl, wherein the striker plate can be set to an open position and to at least one closed position, wherein the pawl can be set to an engaged position, in which it holds the striker plate in the at least one closed position, and into a raised position, in which it releases the striker plate. The motor vehicle lock comprises an actuation lever, more particularly an internal actuation lever, which can be moved in an actuation stroke from an initial position into an actuation position, wherein a switchable coupling arrangement, which can be switched between an engaged state and a disengaged state, is arranged between the actuation lever and the pawl, wherein the coupling arrangement switches out of the disengaged state into the engaged state on a first actuation stroke of the actuation lever from the initial position, wherein the first actuation stroke is an empty stroke in respect of raising the pawl, and wherein the pawl can be raised by a second actuation stroke of the actuation lever from the initial position into the actuation position. The coupling arrangement switches from the engaged state into the disengaged state as a result of the second actuation stroke.

### CROSS-REFERENCE TO RELATED APPLICATIONS

This application is the U.S. National Phase of PCT/EP2021/064663 filed Jun. 1, 2021 which claims priority to German Application No.: DE 10 2020 114 902.6 filed Jun. 4, 2020, the entire disclosures of which are incorporated by reference herein.

### TECHNICAL FIELD

The present disclosure relates to a motor-vehicle lock.

### BACKGROUND

Motor-vehicle locks may be assigned to any locking element of a motor vehicle. In this respect, the expression “locking element” is to be interpreted broadly. It encompasses for example a side door, in particular a rear side door, a rear door, a tailgate, a trunk lid, a front hood, an engine hood or the like. The locking element can be articulated on the body of the motor vehicle in the manner of a pivoting door or in manner of a sliding door.

In the case of modern motor-vehicle locks, crash safety is of particular importance. The primary concern here is that crash accelerations acting on the locking element must not, under any circumstances. lead to a malfunction of the motor-vehicle lock, in particular to an unwanted opening of the motor-vehicle lock.

### SUMMARY

The present disclosure attempts to address the problem of designing and developing a motor-vehicle lock in such a way that it is further optimized with regard to the crash-safety function.

An essential factor is the basic consideration that, after performance of a double stroke, by way of which the motor-vehicle lock can be unlocked and opened, the motor-vehicle lock is automatically back in the locking state. This is realized according to the proposal by way of the second actuating stroke of the double stroke, such as by way of the return movement, this being discussed in more detail below. A major advantage of a motor-vehicle lock designed in such a manner is that the motor-vehicle lock is locked again after the opening without there being a need for a separate user intervention. In a crash situation, it is consequently ensured that, from this state, a crash-induced actuating stroke, which, with actuation of the motor-vehicle lock as intended, corresponds to a first actuating state of the actuating lever, cannot lead to raising of the pawl and accordingly cannot lead to unwanted opening of the lock catch.

As an example, it is proposed that the coupling arrangement is shifted from the engaging state into the disengaging state by way of the second actuating stroke.

The shifting from the engaging state into the disengaging state results in the motor-vehicle lock being transferred into the locking state. This may occur without a motor, that is to say purely mechanically, so that locking of the motor-vehicle lock can be realized also independently of a central-locking drive. It is therefore ensured that, after an opening and subsequent closing of a locking element equipped with the motor-vehicle lock according to the proposal, e.g., of a side door, for example a rear side door, the motor-vehicle lock is automatically locked, whereby the latter and accordingly the locking element cannot open in a crash-induced manner.

In this respect, it should be emphasized that an actuating stroke of the respective actuating lever always means the entire stroke movement, comprising the outward movement from the starting position into the actuating position and the return movement back into the starting position. Thus, whenever reference is made to the coupling arranged being switched from the engaging state into the disengaging state by way of the second actuating stroke, this generally relates to the entire second actuating stroke comprising the outward movement and the return movement. However, it is particularly preferable, as will be further discussed below, for the return movement of the second actuating stroke to be the movement during which the coupling arrangement is guided from the engaging state back into the disengaging state, in order for the motor-vehicle lock to be locked.

According to one or more embodiments, the pawl can in principle be raised in a motor-driven manner also for example via the further actuating lever (further discussed below), in particular outer actuating lever, or else directly.

In another embodiment, the first actuating stroke and/or the second actuating stroke of the actuating lever, which is in particular an inner actuating lever, is able to be performed without a motor. According to another configuration, a motor-driven performance of the first and/or second actuating stroke is however also conceivable, in principle.

As described herein, the coupling arrangement is shifted into the engaging state during the outward or return movement of the first actuating stroke, and/or the coupling arrangement is shifted into the disengaging state during the outward or return movement of the second actuating stroke. As already mentioned, the locking or the shifting of the coupling arrangement into the disengaging state occurs, for example, due to the return movement of the second actuating stroke and in particular during the return movement. In an alternative configuration, it may however also be provided that the locking occurs due to the outward movement of the second actuating stroke of the actuating lever and in particular during the outward movement.

One or more embodiments relate to the further actuating lever already mentioned above, via which the pawl is likewise able to be raised, although here independently of the coupling arrangement. It is thus possible for the motor-vehicle lock to be opened from the locking state by way of the further actuating lever too.

The further actuating lever may be an outer actuating lever, whereas the actuating lever which has to perform the double stroke in order to raise the pawl is preferably an inner actuating lever. It is in this case particular preferably a fact that, in the engaging state, the actuating lever, that is to say preferably the inner actuating lever, performing the second actuating stroke acts on the further actuating lever, that is to say preferably the outer actuating lever, via the coupling arrangement. The pawl is then raised via the further actuating lever.

One or more embodiments, relate to a coupling lever of the coupling arrangement, which, in the disengaging state of the coupling arrangement, is in a disengaging position and, in the engaging state of the coupling arrangement, is in an engaging position. The coupling lever then serves, in the engaging position, for transmission of the adjusting movement from the actuating lever to the further actuating lever. The further actuating lever can then raise the pawl.

One or more embodiments, relate to a securing lever which first of all performs a securing function, specifically by securing, in a securing position, the coupling lever in the disengaging position. The securing lever can however also perform an ejector function and, in this respect, also form an ejector lever, specifically by adjusting the coupling lever from an engaging position into a disengaging position during the second actuating stroke of the actuating lever, in particular toward the end of the return movement of the second actuating stroke (claim 12). In the disengaging position, the securing lever then secures the coupling lever against adjustment into an engaging position again, while performing its securing function.

One or more embodiments define various lever contours for engagement with a lever respectively interacting therewith, specifically actuating-lever contours of the actuating lever, of which one can interact with the securing lever and the other one can interact with the coupling lever, and coupling-lever contours, which interact with the securing lever in different lock states, specifically in the locking state, on the one hand, and in the unlocking state, on the other hand.

Another embodiment defines that the respective actuating lever is spring-preloaded in the direction of its starting position. In this context, it should be emphasized that also the coupling lever can be spring-preloaded, specifically in particular in the direction of its engaging position, and/or the securing lever can be spring-loaded, e.g., in the direction of its securing position.

### BRIEF DESCRIPTION OF THE DRAWINGS

The invention will be discussed in more detail below on the basis of a drawing illustrating merely one exemplary embodiment, in which drawing:

FIG. 1 shows a locking element of a motor vehicle in the form of a rear side door with a motor-vehicle lock according to the proposal,

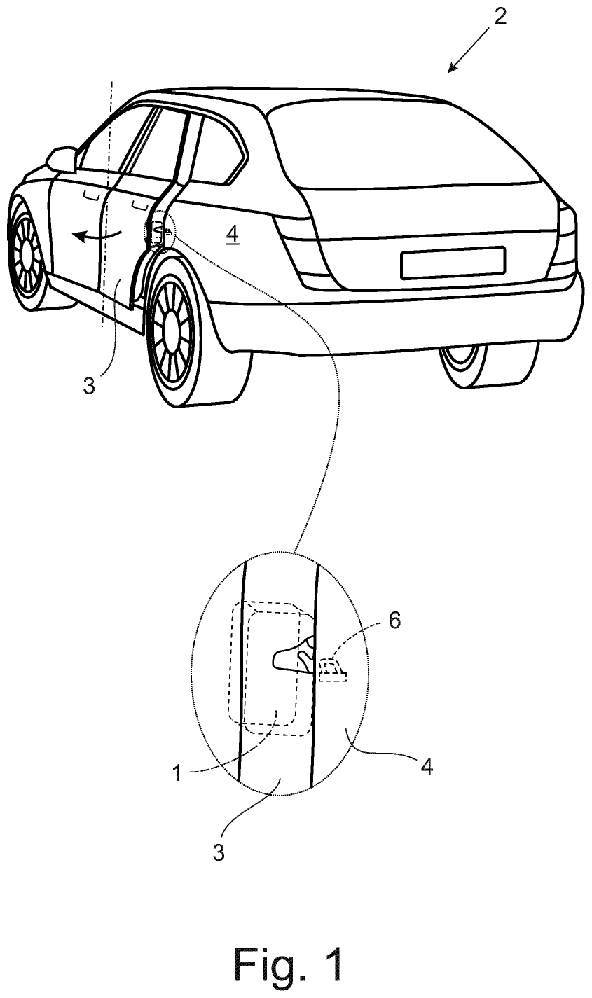

FIG. 2 shows essential adjustable components of the motor-vehicle lock as per FIG. 1 in a perspective illustration and partly in an exploded illustration,

FIG. 3 shows some of the adjustable components of the motor-vehicle lock as per FIG. 1 during a first actuating stroke of an actuating lever of the motor-vehicle lock,

FIG. 4 shows the components from FIG. 3 during the outward movement of a second actuating stroke of the actuating lever, which follows the first actuating stroke, and

FIG. 5 shows the components from FIG. 3 during a return movement of the second actuating stroke of the actuating lever.

### DETAILED DESCRIPTION OF EMBODIMENTS

A known motor-vehicle lock is described in DE 20 2013 004 026 U1 and is equipped with a lock catch which is pivotable about a geometrical lock-catch axis, and with at least one pawl which is pivotable about a geometrical pawl axis, wherein the lock catch is adjustable into an open position and into at least one locked position, and wherein the pawl, in a lowered position, holds the lock catch in the locked position, and, in a raised position, releases the lock catch. The motor-vehicle lock furthermore has an actuating lever, in particular an inner actuating lever that is coupled to a door inner handle in the fitted state and an outer actuating lever that is coupled to a door outer handle in the fitted state, which is pivotable about a geometrical actuating-lever axis. The motor-vehicle lock is in this case designed in such a way that, in particular from the inner actuating lever, a double stroke is necessary to open the motor-vehicle lock. In this respect, in a first actuating stroke of the actuating lever, a coupling arrangement is shifted from a disengaging state into an engaging state, and only in a second actuating stroke of the actuating lever is the pawl raised, so as to release the lock catch, via the then engaged coupling arrangement.

The known motor-vehicle lock is advantageous insofar as a first actuating stroke of the actuating lever, when the coupling arrangement is in its disengaging state and the motor-vehicle lock is locked, is an idle stroke with regard to the raising of the pawl. The motor-vehicle lock has a high level of crash safety since an actuation of the actuating lever attributed to crash accelerations would likewise bring about only an idle stroke, whereby raising of the pawl and opening of the lock catch can be prevented. However, this crash-safety function requires that the motor-vehicle lock is locked, that is to say the coupling arranged is in its disengaging state.

In this case, it is challenge for a locked state of the motor-vehicle lock to be brought about in as simple a manner as possible.

The motor-vehicle lock 1 according to the proposal that is illustrated in the drawing can be assigned to any locking element of a motor vehicle 2. With regard to the further understanding of the expression “locking element”, reference may be made to the introductory part of the description. In the exemplary embodiment that is illustrated and to this extent preferred, the locking element is a side door 3, here a rear side door, of the motor vehicle 2. All statements in this regard apply correspondingly to all other types of locking elements.

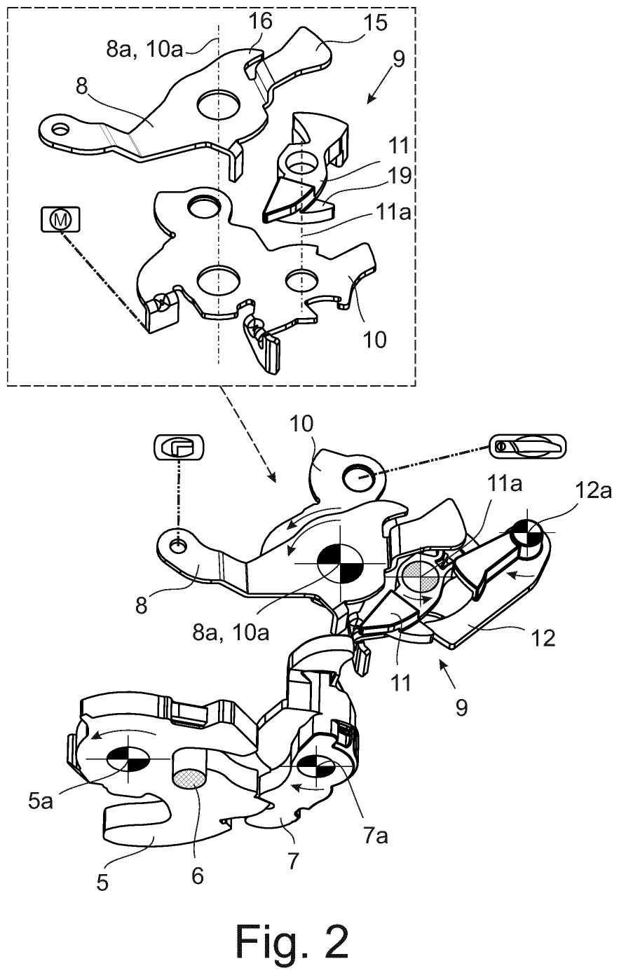

For generating a holding action between the side door 3 and the body 4 of the motor vehicle 2, the motor-vehicle lock 1 is provided with a lock catch 5 which is adjustable about a geometrical lock-catch axis 5a into an open position, into at least one locked position, in particular into a main locked position, which is illustrated in FIG. 2, and possibly into a pre-locked position, which is between the open position and the main locked position. The lock catch 5 interacts in a conventional manner with a locking part 6, uch as in the form of a striker, in order to hold the side door 3 in its respective locked position. In this case, the lock catch 5 is arranged on the side door 3, while the locking part 6 is arranged on the motor-vehicle body 4. Provision may also be made the other way around in this respect.

For realizing the above holding action, the motor-vehicle body 1 has at least one pawl 7, here exactly one pawl 7. The solution according to the proposal can however also be readily applied to a two-pawl system. For the purpose of providing a clear illustration, the following statements relate however to an arrangement having only a single pawl 7.

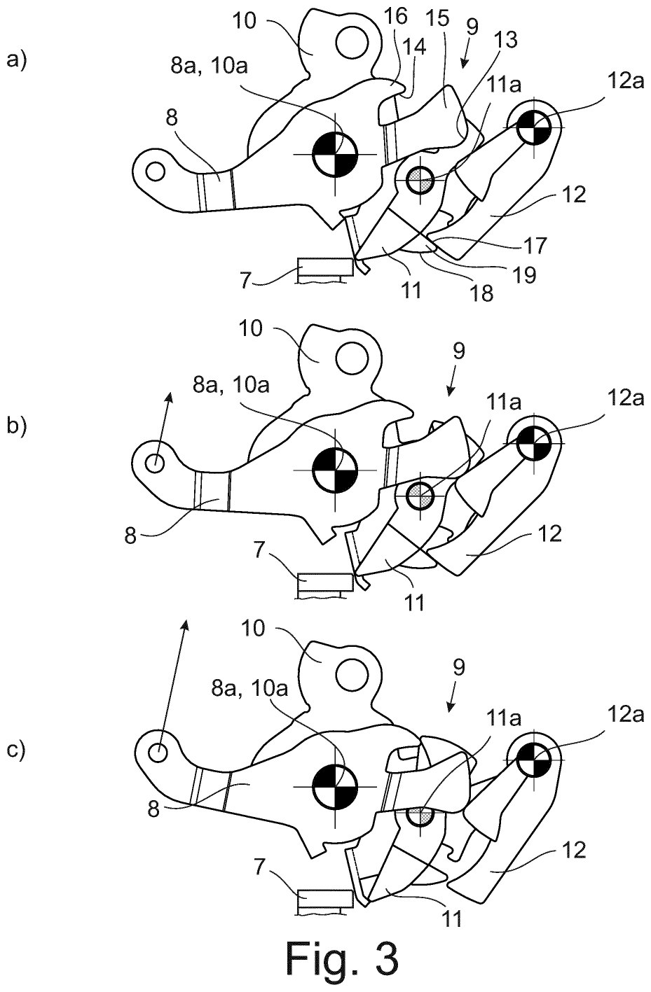

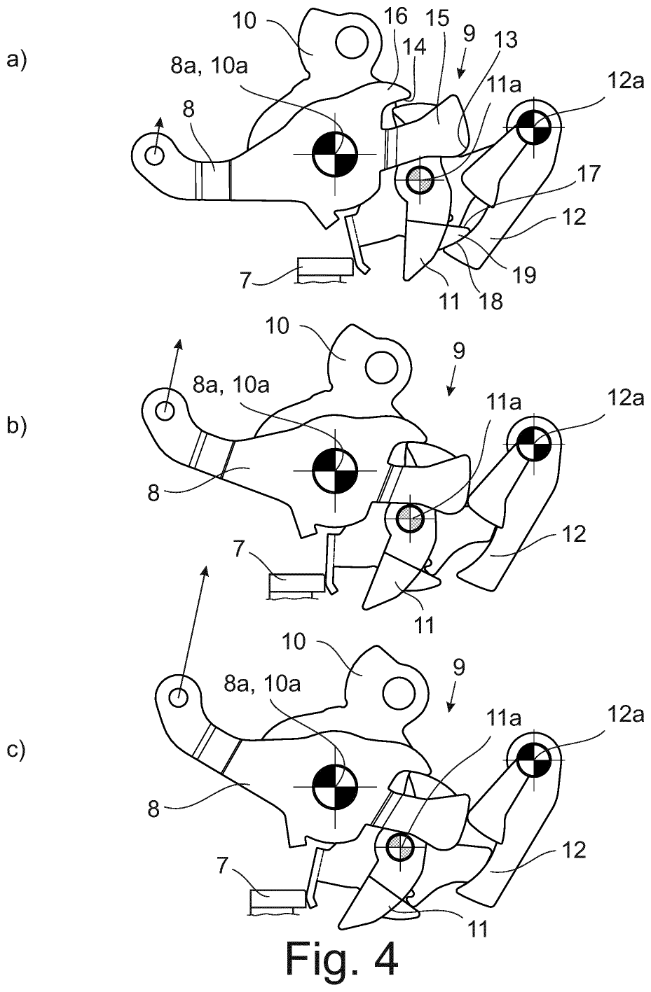

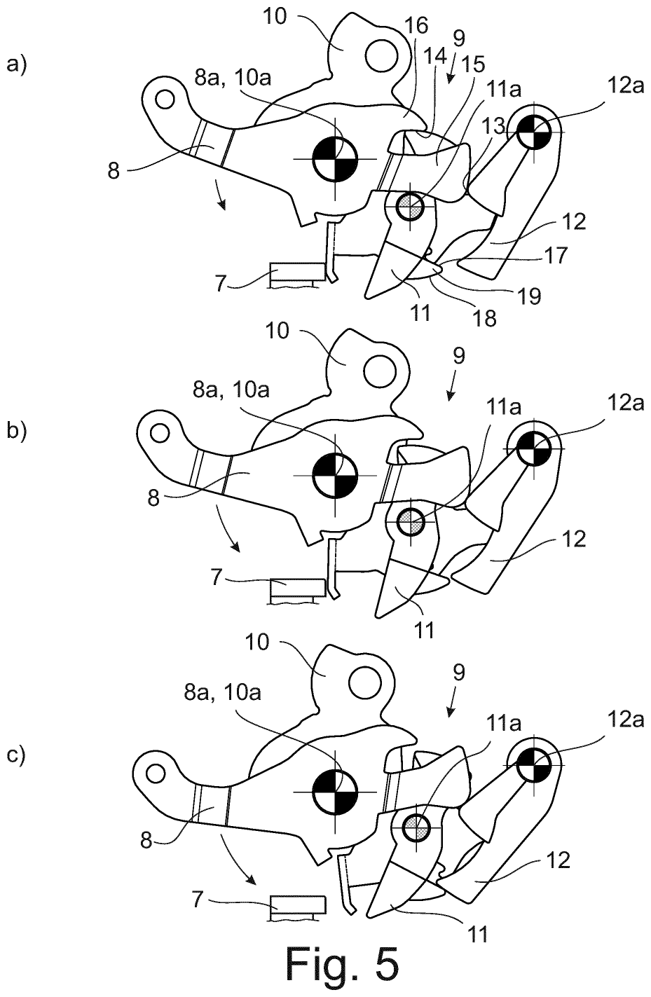

The pawl 7, which here is pivotable about a geometrical pawl axis 7a, is adjustable into a lowered position (FIG. 2, FIG. 3, FIG. 4a)), in which it holds the lock catch 5 in the at least one locked position, and into a raised position (FIG. 4c), FIG. 5), in which it releases the lock catch 5.

For raising the pawl 7, the motor-vehicle lock 1 has an actuating lever 8 which is pivotable about a geometrical actuating-lever axis 8a and which is adjustable, in an actuating stroke, from a starting position (FIG. 3a)) into an actuating position (FIG. 4c)). If a double stroke is carried out, which will be discussed in more detail below, the actuating positions in the actuating strokes are preferably identical but may also be different. This applies correspondingly to the starting positions. Within the context of the proposal, an actuating stroke always comprises an outward movement from the starting position into the respective actuating position and a return movement back into the starting position.

This actuating lever 8 may be an inner actuating lever, that is to say a lever which, in the fitted state, is coupled to a door inner handle of the side door 3. This actuating lever 8 is not necessarily the only one of the motor-vehicle lock 1, this also being discussed in more detail below.

Furthermore, between the actuating lever 8 and the pawl 7, there is arranged a coupling arrangement 9 which is shiftable between an engaging state (FIG. 4) and a disengaging state (FIG. 3). By way of a first actuating stroke of the actuating lever 8 from the starting position into the actuating position, the outward movement of which is illustrated in the sequence of FIGS. 3a) to c), the coupling arrangement 9 is shifted from the disengaging state (FIG. 3) into the engaging state (FIG. 4). Said first actuating stroke is in this case an idle stroke with regard to the raising of the pawl 7. The pawl 7 is thus not raised by way of this actuating stroke.

In the engaging state, the pawl 7 is able to be raised by way of a second actuating stroke of the actuating lever 8 from the starting position into the actuating position, the outward movement of which is illustrated in the sequence of FIGS. 4a) to c). The raising of the pawl 7 is realized such as during the outward movement of the second actuating stroke, but, according to a different embodiment, may also be provided during the return movement of the second actuating stroke.

It is now essential that the coupling arrangement 9 is shifted from the engaging state into the disengaging state by way of the second actuating stroke.

The shifting from the engaging state into the disengaging state results in the motor-vehicle lock 1 being locked. The locking takes place here automatically due to the second actuating stroke, preferably by way of the return movement thereof, such as without a motor. By way of a double stroke made up of the first and second actuating strokes, it is for example, the case that the motor-vehicle lock 1 is always transferred automatically into the locking state without there being a need for a separate user intervention, in order for the motor-vehicle lock to be locked again after the unlocking and opening. As an example, the shifting of the coupling arrangement 9 from the disengaging state into the engaging state is realized without a motor too.

The term “without a motor” means here and below that the respective adjustment is realized purely mechanically without an electric drive motor. The adjustment is then realized in particular manually during the outward movement of the respective actuating stroke and/or in particular in a spring-driven manner, owing to a spring preload acting on the respective lever, during the return movement.

As an example, it is in this case a fact that the coupling arrangement 9 remains in the disengaging state until the actuating lever 8, in particular after the lock catch 5 is again in its respective locked position, in particular main locked position, and/or the pawl 7 is again in its lowered position, performs another actuating stroke from the starting position, the actuating stroke then corresponding again to the first actuating stroke of the actuating element 8.

The first actuating stroke of the actuating lever 8 and/or the second actuating stroke of the actuating lever 8 are/is able to be performed without a motor. The outward movement of the respective actuating stroke is then realized in particular manually, and/or the return movement is then realized in particular in a spring-driven manner, owing to the spring preload. In one embodiment (not illustrated here), it is also conceivable for the first and/or the second actuating stroke to be able to be performed in a motor-driven manner, that is to say by way of an in particular electric drive motor. In the exemplary embodiment illustrated here, however, both the first actuating stroke and the second actuating stroke are realized exclusively without a motor.

As an example, it is then the case that, during the outward or return movement of the first actuating stroke of the actuating lever 8, the coupling arrangement 9 is shifted from the disengaging state into the engaging state. This takes place for example, during the return movement of the first actuating stroke (transition from FIG. 3c) to FIG. 4a)). Additionally or alternatively, it is possible, as in the present exemplary embodiment, for provision to be made such that, during the outward or return movement of the second actuating stroke of the actuating lever 8, the coupling arrangement 9 is shifted from the engaging state into the disengaging state. This may be realized during the return movement, in particular toward the end of the return movement of the second actuating stroke (further progression of the return movement after the state shown in FIG. 5c)).

As already indicated above, it is not absolutely necessary for the motor-vehicle lock 1 according to the proposal to have only a single actuating lever 8. As an example, the motor-vehicle lock 1 additionally has a further actuating lever 10, which is pivotable about a geometrical actuating-lever axis 10a and is likewise adjustable, in an actuating stroke, from a starting position into an actuating position. It can be seen from FIG. 2 that, for example, the geometrical actuating-lever axes 8a and 10a of the two actuating levers 8 and 10 extend coaxially with respect to one another. In principle, it is possible for the two actuating-lever axes 8a, 10a also to extend differently, in particular parallel and/or spaced apart from one another.

As an example, the further actuating lever 10 is an an outer actuating lever, that is to say a lever which, in the fitted state, is coupled to a door outer handle. The pawl 7 is able to be raised by way of the actuating stroke able to be performed by the further actuating lever 10, such as by way of the outward movement thereof. In this case, the actuating stroke may be realized by motor means, specifically for example, independently of the coupling arrangement 9, that is to say independently of whether the motor-vehicle lock 1 is locked or unlocked. The actuating stroke may however also be realized via the first actuating lever 8 in the engaging state of the coupling arrangement 9, as will be described below. At this juncture, it should be emphasized that, according to another embodiment, it is in principle possible for the pawl 7 to be raised by motor means also in another manner, such as directly, that is to say without an interconnected further actuating lever.

As illustrated by the sequence in FIGS. 4a) to c), it is, for example, the case that, in the engaging state, the actuating lever 8 performing the second actuating stroke acts on the further actuating lever 10 via the coupling arrangement 9. The further actuating lever 10 consequently performs the aforementioned actuating stroke and raises the pawl 7, such as during the outward movement of its actuating stroke. The further actuating lever 10 thus forms in this respect a release lever which, in terms of drive, is arranged between the first actuating lever 8, such as the inner actuating lever, and the pawl 7 and which, for raising the pawl 7, is able to be brought into raising engagement or is in engagement therewith. This release lever can, as already mentioned, also function as an outer actuating lever, but may in principle also be another lever, which, in terms of drive, is arranged between the first actuating lever 8, such as the inner actuating lever, and the pawl 7 and which is such as not coupled in the fitted state to a door outer handle.

The coupling arrangement 9 may include a coupling lever 11 which is pivotable about a geometrical coupling-lever axis 11a. The coupling lever 11, in the disengaging state of the coupling arrangement 9, is in a disengaging position in which the coupling lever 11 is out of coupling engagement with the actuating lever 9 during an actuating stroke of the actuating lever 8, such as during the outward movement thereof, possibly also during the return movement thereof. In FIGS. 3a) to c), the coupling lever 11 is in each case in such a disengaging position. An adjustment movement can then not be transmitted from the actuating lever 8 to the further actuating lever 10.

Furthermore, the coupling lever 11, in the engaging state of the coupling arrangement 9, is in an engaging position in which the coupling lever 11 is in coupling engagement with the actuating lever 8, or comes into coupling engagement with the actuating lever 8, during an actuating stroke of the actuating lever 8, such as during the outward movement thereof, possibly also during the return movement thereof. This is shown in FIGS. 4a) to c), wherein, in FIG. 4a), although the coupling lever 11 is already in an engaging position, the actuating lever 8 is not yet in coupling engagement therewith. The coupling lever 11 first comes into coupling engagement with the actuating lever 8 during the further outward movement of the second actuating stroke (FIGS. 4b) and c)). With a coupling engagement, it is then possible for an adjustment movement to be transmitted from the actuating lever 8 to the further actuating lever 10 such that the pawl 7 can be raised.

The geometrical coupling-lever axis 1 la extends, for example, parallel to the geometrical actuating-lever axis 8a of the actuating lever 8 and/or, as is likewise provided here, parallel to the geometrical actuating-lever axis 10a of the further actuating lever 10. The geometrical coupling-lever axis 11a may be arranged for conjoint rotation on the further actuating lever 11, that is to say the geometrical coupling-lever axis 11a moves along with the further actuating lever 10 when the latter is adjusted between its starting position and its actuating position. The coupling lever 11 may be spring-preloaded in the direction of its engaging position.

Furthermore, provision is made of a securing lever 12 which is pivotable about a geometrical securing-lever axis 12a and which, in a securing position, secures the coupling lever 11 in a disengaging position. The expression “secures” means here that the securing lever 12 firmly holds the coupling lever 11, so that the coupling lever 11 cannot be adjusted into its engaging position. Such a state of the motor-vehicle lock 1 is illustrated in FIG. 3a), FIG. 3b) and FIG. 5c). The securing lever 12 may be spring-preloaded into its securing position.

The securing lever 12 then comes, during the first actuating stroke of the actuating lever 8, such as during the outward movement thereof, possibly also the return movement thereof, into engagement with the actuating lever 8, this being shown in FIGS. 3b) and c). The securing lever 12 is adjusted by the actuating lever 8 from the securing position into a raised position, which is shown in FIG. 3c). In this raised position, the securing lever 12 releases the coupling lever 11. As an example, the coupling lever 11 is then adjusted, such as in a spring-driven manner by the spring preload, into an engaging position, as is illustrated in FIG. 4a).

As an example, after completion of the return movement of the first actuating stroke of the actuating lever 8, the securing lever 12 comes out of engagement with the actuating lever 8. In principle, this can occur, in one embodiment (not illustrated here), also after completion of the outward movement and prior to the return movement of the actuating stroke. The fact that the securing lever 12 then comes out of engagement with the actuating lever 8 means that the securing lever 12 is adjusted, such as in a spring-driven manner owing to the spring preload, from its raised position back in the direction of its securing position, which is apparent in FIGS. 3c) and 4a) when viewed together. In this state of the motor-vehicle lock 1, which is then shown in FIG. 4a), it is then the case that the securing lever 12 holds the coupling lever 11 in a defined engaging position, such as as long as the coupling lever 11 is not yet in coupling engagement with the actuating lever 8. Additionally or alternatively, in this state of the motor-vehicle lock 1, the further actuating lever 10 holds the coupling lever 11 in a defined engaging position, such as as long as the coupling lever 11 is not yet in coupling engagement with the actuating lever 8. The defined engaging position is illustrated in FIG. 4a).

During the second actuating stroke of the actuating lever 8, such as during the outward movement thereof, but possibly also during the return movement thereof, the securing lever 12 comes back into engagement with the actuating lever 8, which is shown in FIGS. 4b) and c). In this way, the securing lever 12 is adjusted by the actuating lever 8 into a raised position which is remote from the securing position. The securing lever 12 is consequently pivoted away from the geometrical coupling-lever axis 11a and/or the coupling lever 11. As an example, it is in this case a fact that, during the return movement of the second actuating stroke of the actuating element 8, the securing lever 12 is adjusted, such as in a spring-driven manner, again from its raised position into its securing position, in which the securing lever 12 again secures the coupling lever 11 in a disengaging position. FIG. 5c) shows a state in which, although the securing lever 12 certainly secures the coupling lever 11, the coupling lever 11 is not yet completely in the disengaging position. The coupling lever 11 is only driven into the disengaging position by the securing lever 12, with further progression of the return movement of the second actuating stroke, as soon as the actuating lever 8 is no longer, as in FIG. 5c), in engagement with the securing lever 12. This function, here referred to as ejector function, is described in more detail below.

It is thus the case that, during the second actuating stroke of the actuating lever 8, such as during the outward movement thereof (FIG. 4), the geometrical coupling-lever axis 11a is displaced in such a way by an adjustment of the further actuating lever 10 that the securing lever 12, after this has been adjusted, such as in a spring-driven manner, again from its raised position at least partially in the direction of its securing position, comes into engagement again with the coupling lever 11 during the further progression of the second actuating stroke. The displacement of the coupling-lever axis 11a is then of such an extent that the coupling lever 11 does not interfere with the adjustment movement of the securing lever 12 to the securing position thereof. The securing lever 12 then may adjust, after it is in engagement with the coupling lever 11 again, the coupling lever 11 into a disengaging position and secures the latter in the disengaging position. As an example, the securing lever 12 is adjusted in a spring-driven manner by way of the spring preload and adjusts the coupling lever 11 counter to its own spring preload into the disengaging position. The spring preload of the securing lever 12 and/or the lever arm of the securing lever 12 that acts on the coupling lever 11 must therefore be configured in such a way that the coupling lever 11 is able to be displaced in the direction of its disengaging position despite its spring preload.

As illustrated in FIGS. 3 to 5, individual levers have different contours which, for the respective functions, interact with counterpart contours of other levers.

In this respect, it is for example, the case that the actuating lever 8, such as inner actuating lever, comes into engagement with the securing lever 12 via a first actuating-lever contour 13 during the first and/or second actuating stroke.

Additionally or alternatively, as is likewise provided here, the actuating lever 8 comes into coupling engagement with the coupling lever 11 via a second actuating-lever contour 14 during the second actuating stroke.

As an example, the first actuating-lever contour 13 and the second actuating-lever contour 14 lie in different planes in relation to the geometrical actuating-lever axis 8a. “In relation to the geometrical actuating-lever axis” means here and below that the planes are orthogonal to the geometrical actuating-lever axis.

Additionally or alternatively, as here, the coupling lever 11 lies in a different plane, in relation to the geometrical actuating-lever axis 8a, than the first actuating-lever contour 13.

The two actuating-lever contours 15, 16 are preferably different from one another and, such as in the adjustment direction of the actuating lever 8, spaced apart from one another. As an example, various projections 15, 16 are formed on the actuating lever 8, wherein the projection 15 has the first actuating-lever contour 13 and the projection 16 has the second actuating-lever contour 14.

Furthermore, it is the case that the coupling lever 11, while secured in its disengaging position by the securing lever 12, is in engagement with the securing lever 12 via a first coupling-lever contour 17.

Additionally or alternatively, as here, it may be provided that the coupling lever 11, after completion of the outward movement of the first actuating stroke of the actuating lever 8, is in engagement with the securing lever 12 via a second coupling-lever section 18 at least until the actuating lever 8 comes into coupling engagement with the coupling lever 11 during the second actuating stroke.

As an example, the first coupling-lever contour 17 and the second coupling-lever contour 18 lie in the same plane in relation to the geometrical actuating-lever axis 8a.

Additionally or alternatively, as here, it is provided that the first coupling-lever contour 17 and the second coupling-lever contour 18 face away from one another. The coupling-lever contours 17, 18 may be different from one another and, such as in the adjustment direction of the coupling lever 11, spaced apart from one another. As an example, there is formed on the coupling lever 11 a common projection 19, which has both the first coupling-lever contour 17 and the second coupling-lever contour 18.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

Parts List

2 motor vehicle

3 side door

4 motor-vehicle body

5 lock catch

6 locking part

7 pawl

8 first actuating lever

9 second actuating lever

10 actuating lever

11 coupling lever

12 securing lever

13 first actuating-lever contour

14 second actuating-lever contour

15 actuating-lever contours

16 actuating-lever contours

17 first coupling-lever contour

18 second coupling-lever contour

19 common projection

3a position figure

4b second actuating stroke figures

4c position figure

5a geometrical lock-catch axis

7a geometrical pawl axis

8a geometrical actuating-lever axis

10a geometrical actuating-lever axis

11a coupling-lever axis

12a geometrical securing-lever axis

1. A motor-vehicle lock comprising:
a lock catch pivotable about a geometrical lock-catch axis; and
at least one pawl pivotable about a geometrical pawl axis, wherein the lock catch is configured to be adjusted into an open position and into at least one locked position, wherein the at least one pawl is configured to be adjusted into a lowered position, in which the at least one pawl holds the lock catch in the at least one locked position, and a raised position, in which the at least one pawls releases the lock catch,
an actuating lever, configured to pivot about a geometrical actuating-lever axis and configured to be adjusted, during an actuating stroke, from a starting position into an actuating position; and
a coupling arrangement disposed between the actuating lever and the at least one pawl, the coupling arrangement configured to be shifted between an engaging state and a disengaging state, wherein, by way of a first actuating stroke of the actuating lever from the starting position into the actuating position, the coupling arrangement shifts from the disengaging state into the engaging state, wherein the first actuating stroke is an idle stroke with regard to the raising of the at least one pawl, and wherein, in the engaging state, the at least one pawl is configured to be raised by way of a second actuating stroke of the actuating lever from the starting position into the actuating position,
wherein the coupling arrangement is configured to be shifted from the engaging state into the disengaging state by way of the second actuating stroke.

2. The motor-vehicle lock of claim 1, wherein the pawl the at least one pawl is raised during the second actuating stroke of the actuating lever.

3. The motor-vehicle lock claim 2, further comprising:
a motor configured to raise the at least one pawl.

4. The motor-vehicle lock as claimed in claim 1, wherein at least one of the first actuating stroke of the actuating lever and the second actuating stroke of the actuating lever is configured to be performed without a motor.

5. The motor-vehicle lock claim 1, wherein the coupling arrangement is configured to shift from the disengaging state into the engaging state during at least one of:
(a) an outward movement of the first actuating stroke of the actuating lever,
(b) a return movement of the first actuating stroke of the actuating lever,
an outward movement of the second actuating stroke of the actuating lever, and
(d) a return movement of the second actuating stroke of the actuating lever.

6. The motor-vehicle lock of claim 1, further comprising:
a second actuating lever configured to pivot about a second geometrical actuating-lever axis and configured to be adjusted during an actuating stroke, from a starting position into an actuating position, so that during a second actuating stroke of the second actuating lever the at least one pawl is raised.

7. The motor-vehicle lock of claim 6, wherein, in the engaging state, the actuating lever, performing the second actuating stroke, acts on the second actuating lever via the coupling arrangement, and so that the second actuating lever performs the actuating stroke and raises the at least one pawl.

8. The motor-vehicle lock of claim 1, wherein the coupling arrangement includes a coupling lever configured to pivot about a geometrical coupling-lever axis, wherein when the coupling arrangement is in the disengaging state, the coupling lever, is in a disengaging position in which the coupling lever is out of coupling engagement with the actuating lever during an actuating stroke of the actuating lever, and
wherein when the coupling arrangement is in the engaging state, the coupling lever is in an engaging position, in which the coupling lever is in coupling engagement with the actuating lever, or moves into coupling engagement with the actuating lever, during one of the first and second actuating strokes of the actuating lever.

9. The motor-vehicle lock of claim 8, further comprising:
a securing lever configured to pivot about a geometrical securing-lever axis to a securing position, in which the securing lever secures the coupling lever in the disengaging position, and during the first actuating stroke of the actuating lever, the securing lever moves into engagement with the actuating lever and is adjusted by said actuating lever from the securing position into a raised position in which the securing lever releases the coupling lever.

10. The motor-vehicle lock of claim 9, wherein after completion of the first actuating stroke of the actuating lever, the securing lever is adjusted from a raised position of the securing lever towards the securing position and disengages the actuating lever.

11. The motor-vehicle lock of claim 9, wherein during the second actuating stroke of the actuating lever, the securing lever moves into engagement with the actuating lever and is adjusted by the actuating lever into the raised position.

12. The motor-vehicle lock of claim 8, wherein during the second actuating stroke of the actuating lever, the geometrical coupling-lever axis is displaced by an adjustment of the second actuating lever in such a way that the securing lever, after being adjusted again from the raised position least partially in a direction of the securing position, comes into engagement again with the coupling lever during a progression of the second actuating stroke of the actuating lever, and adjusts the coupling lever into a disengaging position and secures the coupling lever in a disengaging position.

13. The motor-vehicle lock of claim 9, wherein the actuating lever is configured to move into engagement with the securing lever via a first actuating-lever contour during at least one of the first actuating stroke and the second actuating stroke.

14. The motor-vehicle lock of claim 8, wherein when the coupling lever is secured in the disengaging position by the securing lever, the coupling lever is in engagement with the securing lever via a first coupling-lever contour.

15. The motor-vehicle lock of claim 6, wherein at least one of the actuating lever and the second actuating lever is spring-preloaded in a direction of a starting position of the actuating lever and the second actuating lever, respectively.

16. The motor-vehicle lock of claim 10, wherein the securing lever is configured to be adjusted in a spring-driven manner.

17. The motor-vehicle lock of claim 13, wherein the actuating lever is configured to move into coupling engagement with the coupling lever via a second actuating-lever contour during the second actuating stroke.

18. The motor-vehicle lock of claim 17, wherein the first actuating-lever contour and the second actuating-lever contour lie in different planes with respect to the geometrical actuating-lever axis.

19. The motor-vehicle lock of claim 18, wherein the coupling lever lies in a different plane than the first actuating-lever contour with respect to the geometrical actuating-lever axis.

20. The motor-vehicle lock of claim 1, wherein the at least one locked position includes a main locked position and a pre-locked position, the pre-locked position is between the open position and the main locked position.
